(19) United States
(12) Patent Application Publication
(10) Pub. No.: US 2026/0217357 A1
(43) Pub. Date: Jul. 30, 2026

(54) FLOOR INCLUDING AT LEAST ONE CONNECTING DEVICE INCORPORATING AT LEAST ONE GUTTER AND ENABLING COMPENSATION OF RELATIVE MOVEMENT IN AT LEAST A LONGITUDINAL DIRECTION

(71) Applicant: Airbus Operations (S.A.S.), Toulouse (FR)

(72) Inventors: Valentina Spinoglio, Toulouse (FR); Benjamin Boisnier, Toulouse (FR)

(21) Appl. No.: 19/454,692

(22) Filed: Jan. 21, 2026

(30) Foreign Application Priority Data
Jan. 28, 2025 (FR) FR2500854

(51) Int. Cl. B64C 1/18

(52) U.S. Cl. CPC B64C 1/18

(57) ABSTRACT

A floor including at least one connecting device connecting first and second panels spaced in a longitudinal direction and including at least one gutter and at least one threshold bar connected to one another by at least one connecting system and respectively at least partly below and above the first and second panels, at least one of the first and second panels, the gutter and the threshold bar being configured to allow movement in the longitudinal direction of the first panel relative to the second panel. An aircraft including at least one such floor is also disclosed.

### TECHNICAL FIELD

The subject matter herein relates to a floor including at least one connecting device that incorporates at least one gutter and enables compensation of relative movement in at least a longitudinal direction and to an aircraft including at least one such floor.

### BACKGROUND

In an embodiment that can be seen in FIG. 1 an aircraft 10 includes a fuselage 12 having a longitudinal axis X that extends between front and rear points 12.1, 12.2 in a longitudinal direction X substantially parallel to the ground when the aircraft 10 is on the ground.

In the remainder of the description a transverse direction Y is perpendicular to the longitudinal direction X and horizontal when the aircraft 10 is on the ground. A vertical direction Z is perpendicular to the longitudinal direction X and the transverse direction Y. A longitudinal plane is a vertical plane parallel to the longitudinal direction X. The front and rear concepts refer to the direction of flow of air around the aircraft 10 when the latter is in flight, the air flowing from front Av to rear Ar.

The aircraft 10 includes at least one substantially horizontal floor 14 in the fuselage 12 dividing the latter into an upper zone ZS above the floor 14 and a lower zone ZI below the floor 14.

In a configuration that can be seen in FIG. 2 the floor 14 includes a first floor part 14.1 in a cockpit and a second floor part 14.2 in a passenger cabin offset toward the rear in the longitudinal direction X relative to the first floor part 14.1.

The first and second floor parts 14.1, 14.2 are separated at the level of a junction zone 16 that extends in the transverse direction Y.

The first and second floor parts 14.1, 14.2 respectively include first and second panels 18.1, 18.2 spaced in the longitudinal direction X at the level of the junction zone 16 and supported by at least one supporting structure including transverse beams and longitudinal rails. In the junction zone 16 the first and second panels 18.1, 18.2 are spaced by a first distance D1 in the longitudinal direction X and their upper surfaces are offset in the vertical direction Z by a second distance D2. In operation the first and second distances D1, D2 can vary.

In an embodiment that can be seen in FIG. 2 the floor 14 includes a threshold bar 20 that includes a base 20.1 rigidly attached to the first floor part 14.1 and first and second flanges 20.2, 20.3 connected to the base 20.1, the first flange 20.2 being above the first floor part 14.1 and the second flange 20.3 being at least in part above the second floor part 14.2.

The threshold bar 20 is configured to provide continuity between the first and second floor parts 14.1, 14.2 by compensating dimensional variations of the first and second distances D1, D2.

The floor 14 includes a sealing layer 22 against the upper surfaces of the first and second floor parts 14.1, 14.2 preventing the passage of liquids from the upper zones ZS to the lower zone ZI. This sealing layer 22 extends continuously over the first and second floor parts 14.1, 14.2 to prevent the passage of liquids in the junction zone 16 between the first and second floor parts 14.1, 14.2. This sealing layer 22 is sufficiently flexible to compensate a dimensional variation of the second distance D2 oriented in the vertical direction. However, this sealing layer 22 does not enable at all (or only with difficulty) compensation of a dimensional variation of the first distance D1 oriented in the longitudinal direction X.

### SUMMARY

The disclosure herein aims to remedy some or all of the disadvantages of the prior art.

To this end the disclosure herein has for object a floor comprising first and second panels spaced from one another in at least a longitudinal direction and at least one connecting device connecting the first and second panels and including at least one threshold bar at least partly above the first and second panels, at least the first panel being mobile relative to the second panel at least in the longitudinal direction.

According to the disclosure herein the connecting device includes at least one gutter configured to collect at least one liquid and at least partly below the first and second panels and at least one connecting system connecting the threshold bar and the gutter, the first panel being between the gutter and the threshold bar and the second panel being between the gutter and the threshold bar without clearance. Also the floor includes at least one clearance and/or at least one sliding element between the first panel and at least a part of the connecting device, namely the gutter and/or the threshold bar.

This solution enables collection of liquids in the gutter and prevents them from flowing under the floor while allowing movement of the first panel relative to the second panel in the longitudinal direction.

According to another feature of the disclosure herein the floor includes at least one first sliding element between the gutter and the first panel and at least one second sliding element between the threshold bar and the first panel.

According to another feature of the disclosure herein the first and second panels respectively have first and second edges oriented toward one another. Also the gutter includes a bottom below the first and second panels and first and second edges on respective opposite sides of the bottom, the first and second edges of the first and second panels being between the first and second edges of the gutter.

According to another feature of the disclosure herein the first edge is nearer the bottom than the second edge.

According to another feature of the disclosure herein the gutter includes first and second flanges that extend the first and second edges on respective opposite sides of the latter, each having a substantially horizontal upper face oriented toward the corresponding first or second panel.

According to another feature of the disclosure herein the first sliding element is a sliding coating rigidly attached to the upper face of the first flange of the gutter.

According to another feature of the disclosure herein the threshold bar has first and second edges above the first and second panels, the first and second edges of the first and second panels being between the first and second edges of the threshold bar.

According to another feature of the disclosure herein the threshold bar has a first lower face oriented toward the first panel, a second lower face oriented toward the second panel, an upper face opposite the first and second lower faces and at least one cutout and/or orifice configured to establish communication between the upper face and the first or second lower face.

According to another feature of the disclosure herein the threshold bar includes first notches on the first edge enabling communication between the upper face and the first lower face and/or second notches on the second edge enabling communication between the upper face and the second lower face.

According to another feature of the disclosure herein the first lower face is substantially horizontal and includes for each first notch a transverse groove extending the first notch.

According to another feature of the disclosure herein the second sliding element is a bead rigidly attached to the threshold bar including a plurality of sections between the transverse grooves.

According to another feature of the disclosure herein the gutter includes at least one evacuation orifice enabling the liquid to exit the gutter.

According to another feature of the disclosure herein the connecting device includes at least one positioning system configured to position the threshold bar relative to the gutter in such a manner that the gutter and the threshold bar are oriented in the same direction.

According to another feature of the disclosure herein the positioning system includes at least one median rib that has a first end rigidly attached to the gutter and a free second end as well as at least one median groove in the threshold bar configured to house without clearance the free second end of the median rib.

According to another feature of the disclosure herein the connecting system includes at least one screw and for each screw an orifice through the threshold bar and a threaded hole in the median rib.

The disclosure herein also has for object an aircraft including at least one floor having any of the above features.

### BRIEF DESCRIPTION OF THE DRAWINGS

Other features and advantages of the disclosure herein emerge from the following description of the disclosure herein given by way of example only and with reference to the appended drawings, in which:

FIG. 1 is a side view of an aircraft;

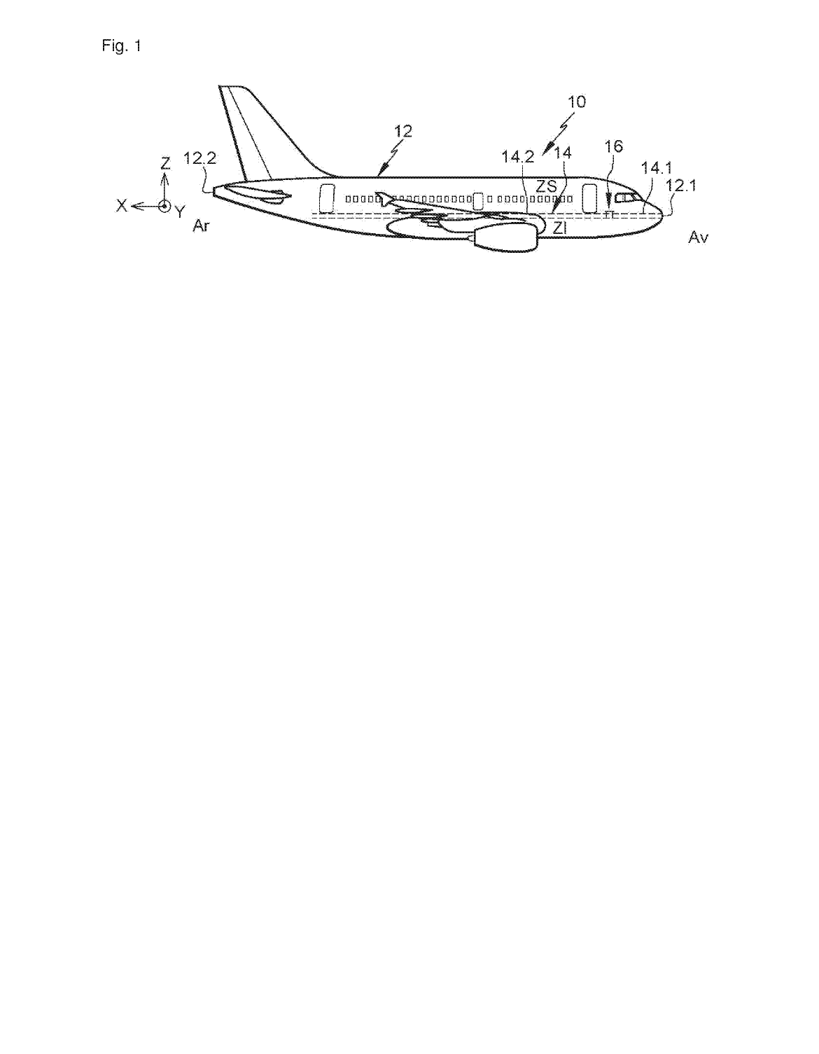

FIG. 2 is a longitudinal section of a part of a floor depicting a prior art embodiment;

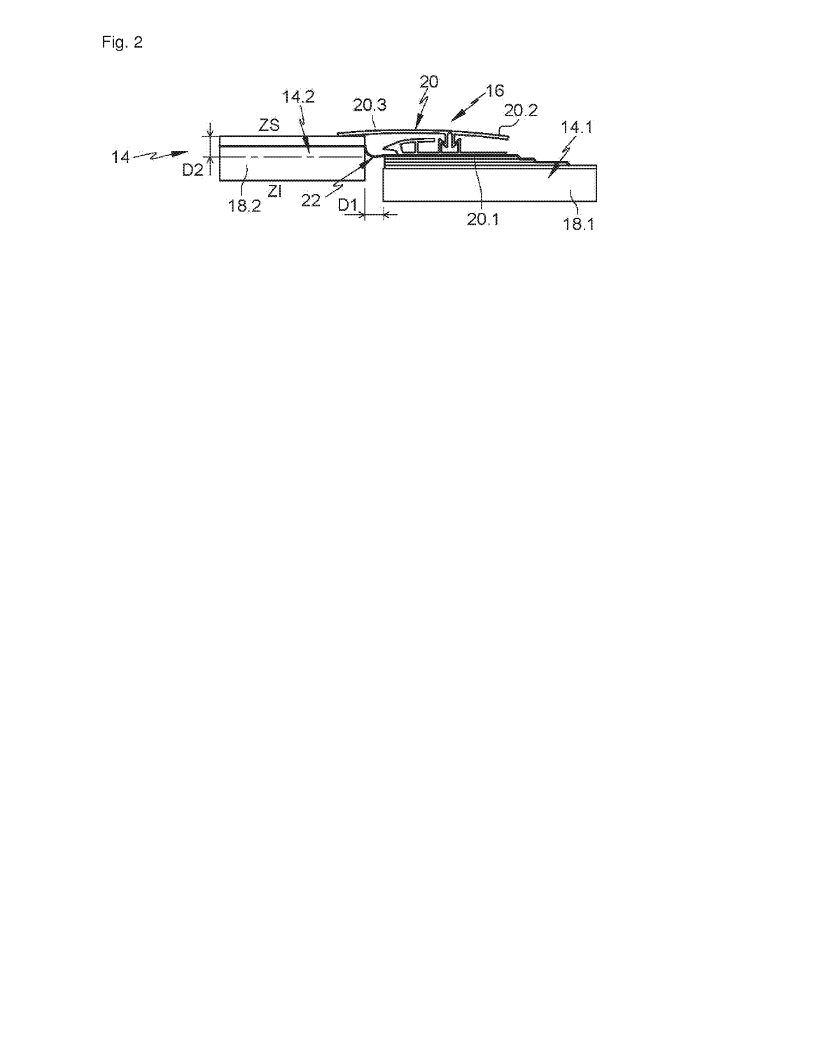

FIG. 3 is a perspective view of a part of a floor depicting an embodiment of the disclosure herein;

FIG. 4 is a cross section of a connecting device connecting two floor parts depicting an embodiment of the disclosure herein;

FIG. 5 is a section on a plane V in FIG. 4 of the connecting device that can be seen in FIG. 4;

FIG. 6 is a section on a plane VI in FIG. 4 of the connecting device that can be seen in FIG. 4;

FIG. 7 is a perspective view of the connecting device that can be seen in FIG. 4 in a disassembled state;

FIG. 8 is a perspective view of a part of a gutter of the connecting device that can be seen in FIG. 4;

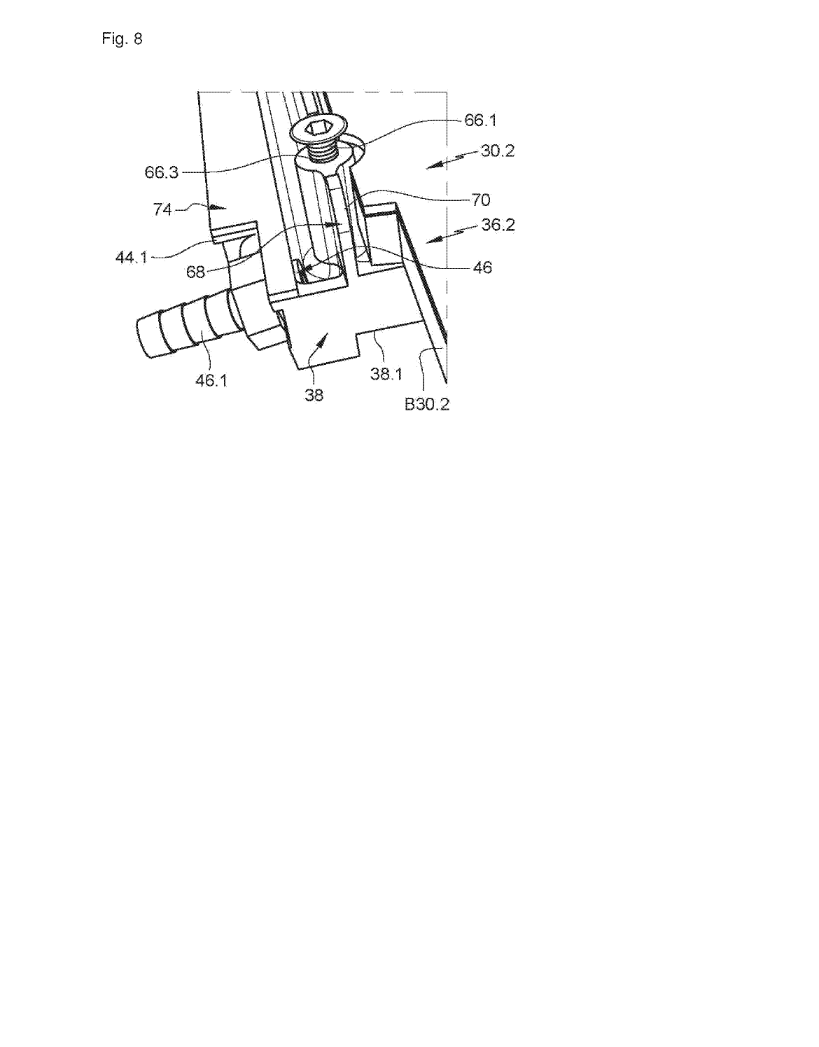

FIG. 9 is a view from above of a part of a gutter of the connecting device that can be seen in FIG. 4; and

FIG. 10 is a perspective view in the disassembled state of the connecting device that can be seen in FIG. 4.

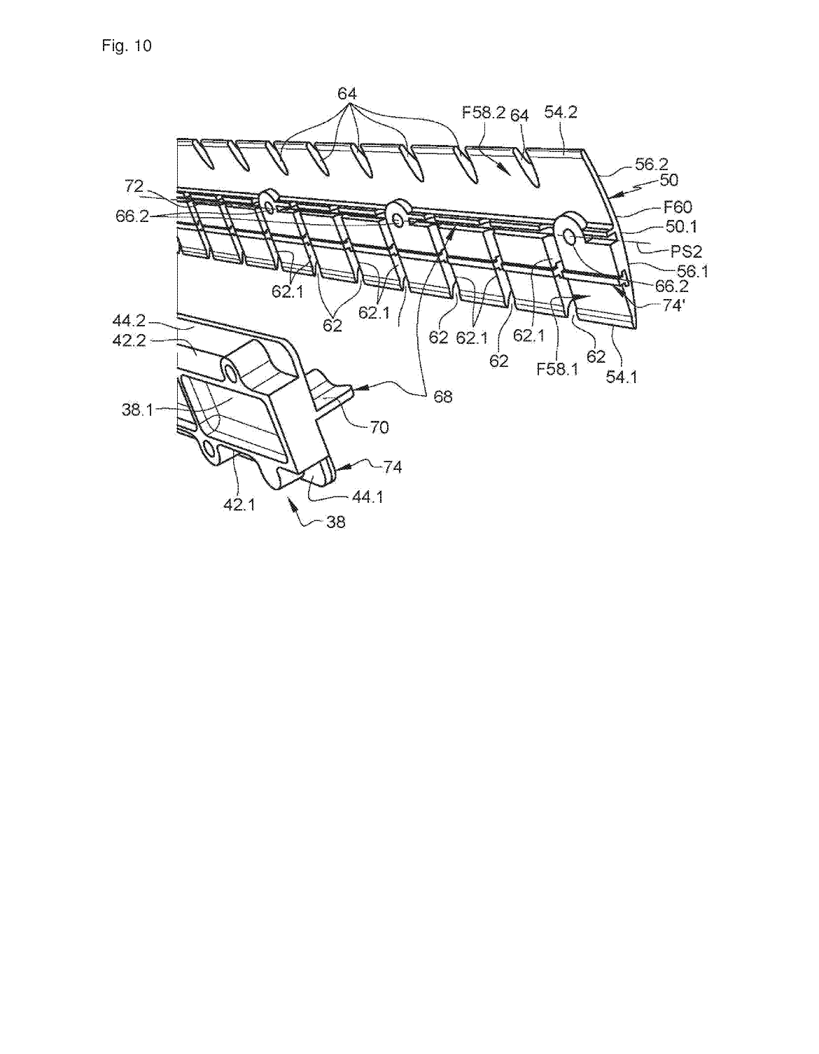

### DETAILED DESCRIPTION

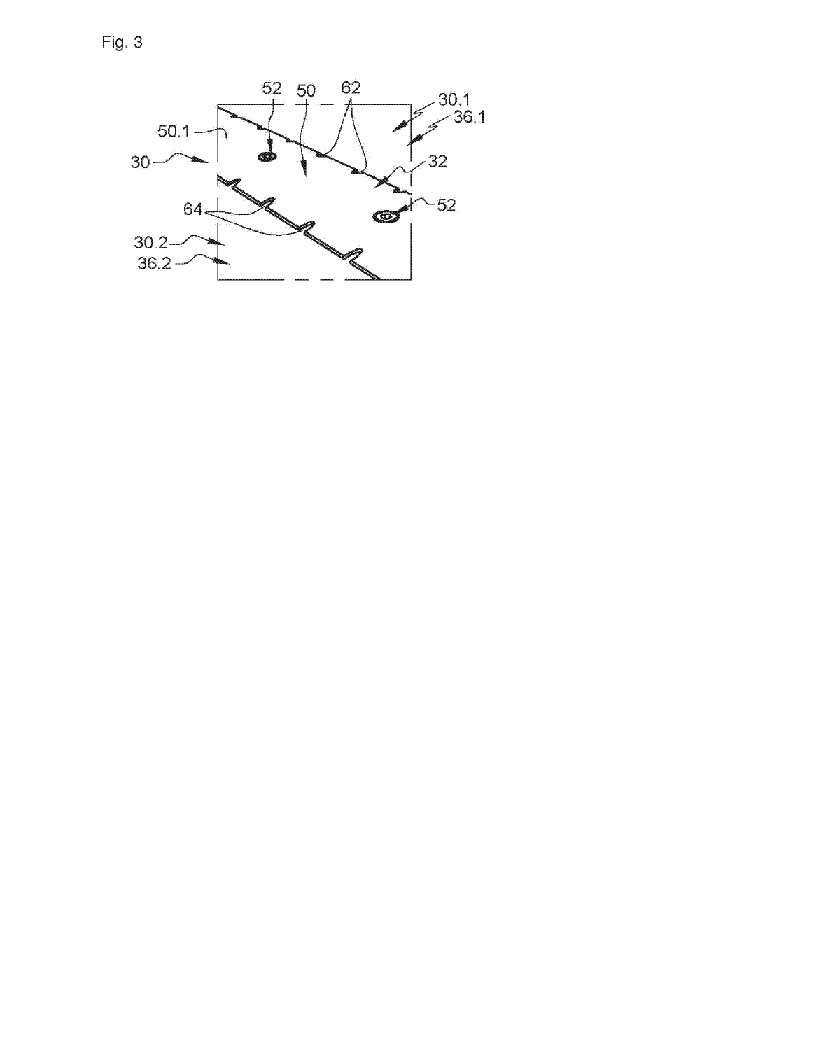

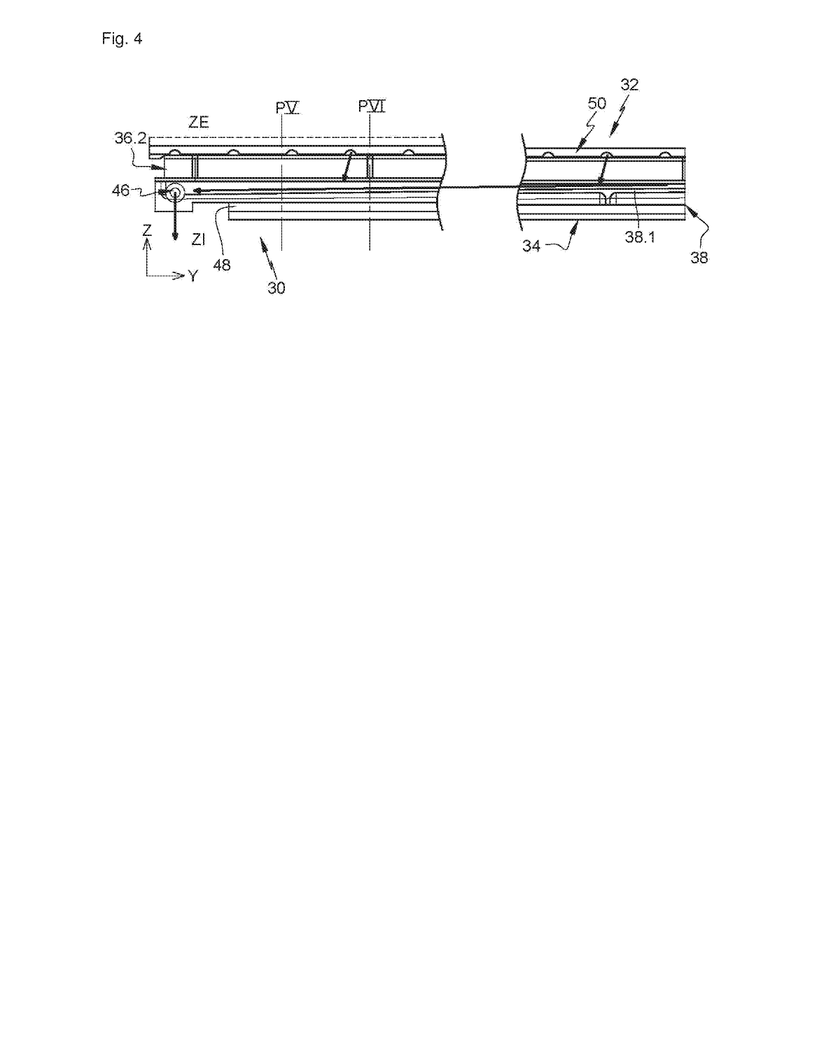

In an embodiment that can be seen in FIGS. 3 and 4 a floor 30 separates an upper zone ZS above the floor 30 and a lower zone ZI below the floor 30 and includes a first floor part 30.1 that has a first edge B30.1, a second floor part 30.2 that has a second edge B30.2 spaced from the first edge B30.1, and a connecting device 32 connecting the first and second floor parts 30.1, 30.2.

In one application an aircraft includes at least one such floor 30, the first floor part 30.1 being in a cockpit and the second floor part 30.2 being in a passenger cabin. In one arrangement the first and second edges B30.1, B30.2 are substantially parallel to each other and to a transverse direction Y and are offset in a longitudinal direction X substantially perpendicular to the transverse direction Y.

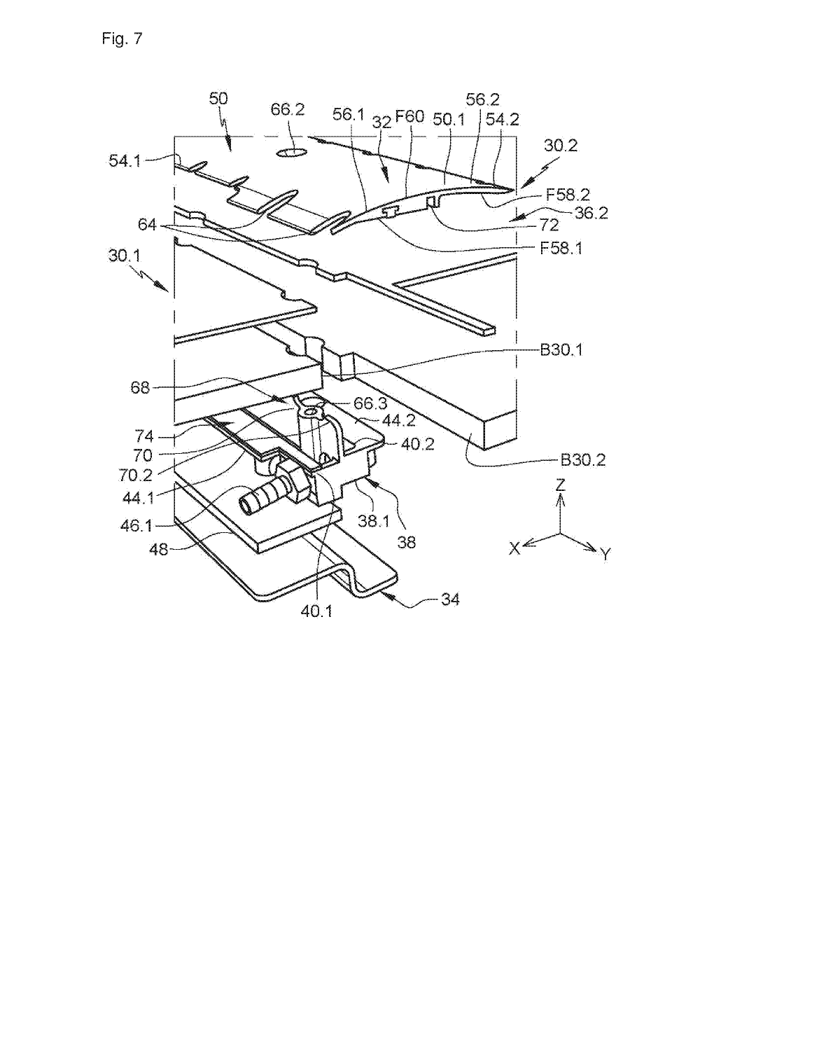

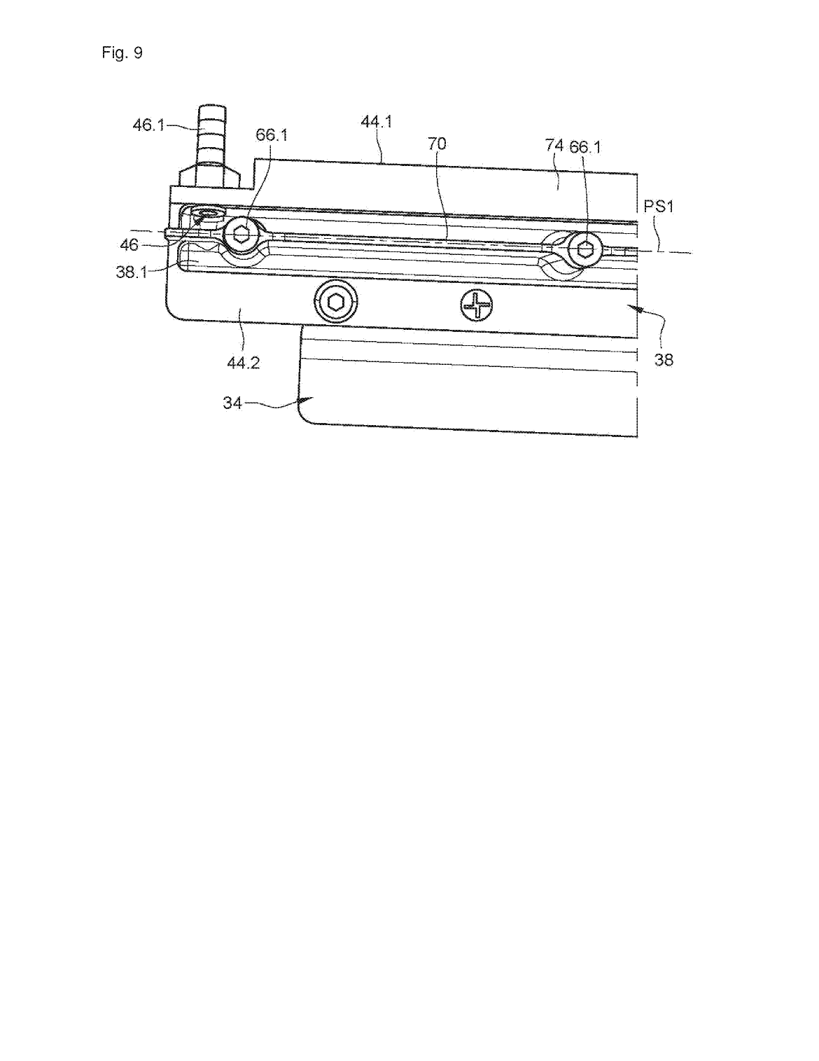

In one embodiment of the disclosure herein the floor 30 includes at least one supporting structure 34 (that can be seen in particular in FIGS. 4 to 7 and 9), at least one first panel 36.1 for the first floor part 30.1, and at least one second panel 36.2 for the second floor part 30.2.

The first and second panels 36.1, 36.2 respectively have first and second upper faces F36.1, F36.2 oriented toward the upper zone ZS, first and second lower faces F36.1', F36.2' respectively opposite the first and second upper faces F36.1, F36.2 and oriented toward the lower zone ZI, and first and second edges F36.1", F36.2" connecting the upper and lower faces F36.1, F36.2, F36.1', F36.2', the first and second edges F36.1", F36.2" being oriented toward one another. The edges F36.1", F36.2" of the first and second panels 36.1, 36.2 are substantially parallel to one another and to the transverse direction Y.

One configuration of the floor 30 includes a supporting structure 34 common to the first and second floor parts 30.1, 30.2. Another configuration of the floor 30 includes a first supporting structure for the first floor part 30.1 and a second supporting structure for the second floor part 30.2. Each supporting structure 34 comprises transverse beams and longitudinal rails substantially perpendicular to the transverse beams.

Each of the first and second panels 36.1, 36.2 includes one or more layers. In one embodiment each of the first and second panels 36.1, 36.2 includes at least one impermeable layer preventing liquids from passing through it. The first and second panels 36.1, 36.2 have identical thicknesses E (the dimension parallel to the vertical direction Z).

Of course the disclosure herein is not limited to the above configurations for the first and second panels 36.1, 36.2. Irrespective of the embodiment, the first and second panels 36.1, 36.2 are spaced from one another in at least a longitudinal direction X and connected by the connecting device 32, at least the first panel 36.1 being mobile relative to the second panel 36.2 in at least the longitudinal direction X. In one arrangement the second panel 36.2 is fixed. The first panel 36.1 can be mobile in the vertical direction Z relative to the second panel 36.2.

The connecting device 32 includes at least one gutter 38 that extends in the transverse direction Y and includes a bottom 38.1 below the first and second panels 36.1, 36.2, first and second edges 40.1, 40.2 on respective opposite sides of the bottom 38.1, and first and second flanks 42.1, 42.2 respectively connecting the bottom 38.1 and the first and second edges 40.1, 40.2. In one arrangement the first and second flanks 42.1, 42.2 are substantially vertical and perpendicular to the bottom 38.1. Of course the disclosure herein is not limited to this arrangement of the gutter 38. Irrespective of the embodiment the gutter 38 is configured to collect at least one liquid and is at least partly below the first and second panels 36.1, 36.2. This gutter 38 has first and second edges 40.1, 40.2 on respective opposite sides of the bottom 38.1 respectively supporting directly or indirectly the first and second panels 36.1, 36.2, the first and second edges F36.1", F36.2" of the first and second panels 36.1, 36.2 being between the first and second edges 40.1, 40.2 of the gutter 38. The first and second edges 36.1, 36.2 of the gutter 38 are substantially parallel to one another. When the gutter 38 is in place its first and second edges 36.1, 36.2 are substantially parallel to the transverse direction Y.

In one arrangement the first and second edges 40.1, 40.2 of the gutter 38 are substantially parallel to one another and substantially symmetrical with respect to a first plane of symmetry PS1. When the gutter 38 is at the level of the floor 30 its first and second edges 40.1, 40.2 are substantially parallel to the transverse direction Y.

In one embodiment of the disclosure herein the gutter 38 includes first and second flanges 44.1, 44.2 that respectively extend the first and second edges 40.1,40.2 on respective opposite sides of the latter, each having a substantially horizontal upper face F44.1, F44.2 oriented toward the lower face F36.1', F36.2' of the corresponding first or second panel 36.1, 36.2.

The gutter 38 includes at least one evacuation orifice 46 enabling a liquid to exit the gutter 38. This evacuation orifice 46 is at the level of a low point of the gutter 38 and/or its bottom 38.1 has at least one slope (that can be seen in FIG. 4) configured to enable liquids to flow toward the evacuation orifice 46. The latter can be extended outside the gutter 38 by a connecting pipe 46.1 enabling connection of a pipe (not represented).

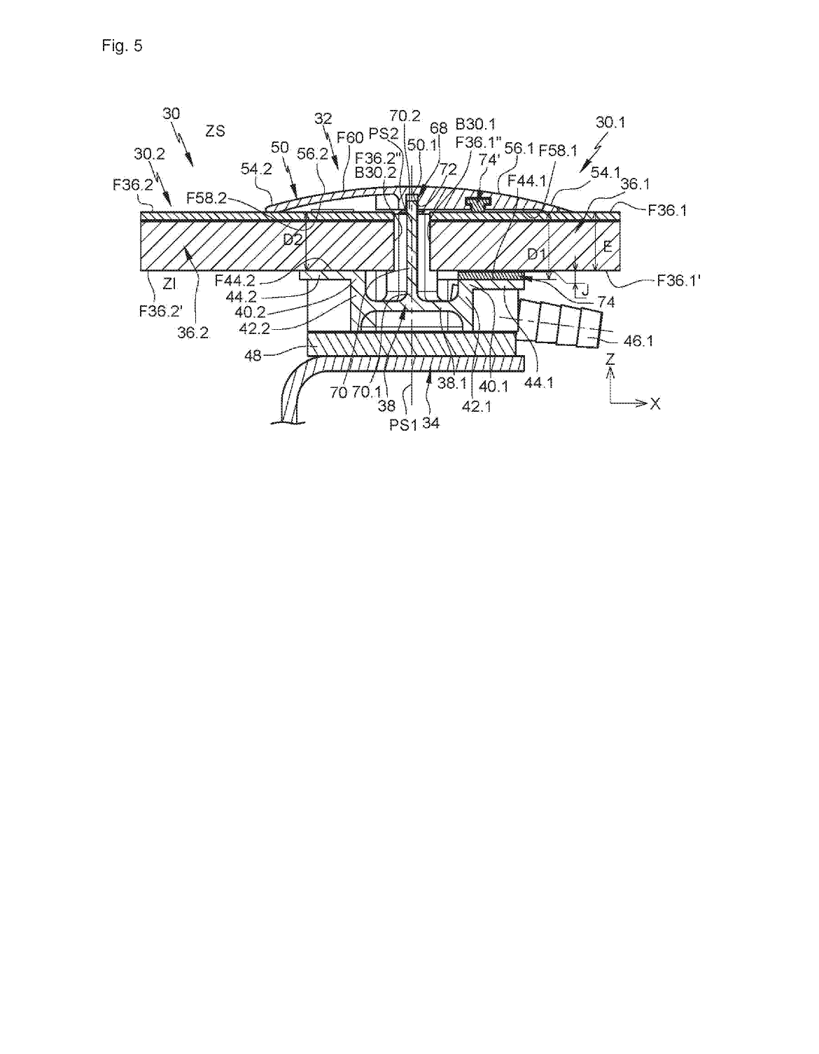

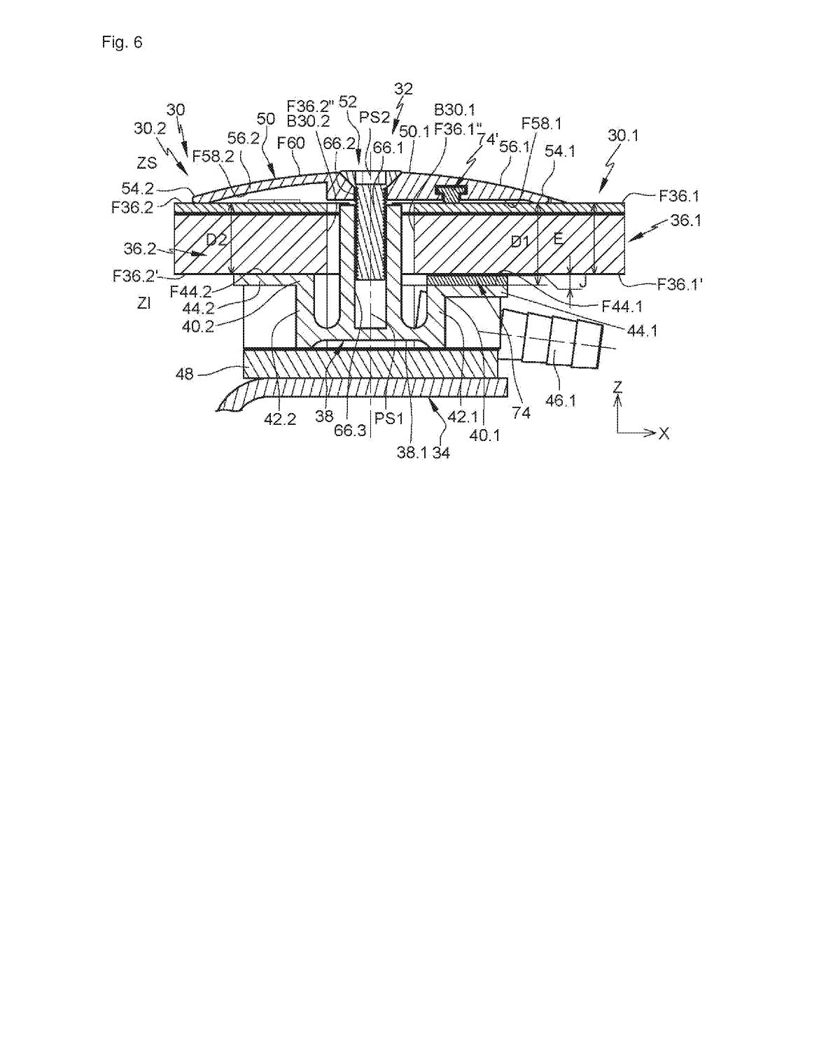

In an embodiment of the disclosure herein that can be seen in FIGS. 5 and 6 in particular the connecting device 32 includes at least one shim 48 between the supporting structure 34 and the gutter 38 to adjust the position of the gutter 38 in the vertical direction Z.

The connecting device 32 also includes at least one threshold bar 50 at least partly above the first and second panels 36.1, 36.2 that cooperates with the first and second panels 36.1, 36.2 and at least one connecting system 52 connecting the threshold bar 50 and the gutter 38. The first and second panels 36.1, 36.2 are between the gutter 38 and the threshold bar 50 and the connecting system 52 is between the first and second panels 36.1, 36.2.

In one embodiment of the disclosure herein the threshold bar 50 includes a central part 50.1, first and second edges 54.1, 54.2, and first and second flanges 56.1, 56.2 respectively connecting the central part 50.1 and the first and second edges 54.1, 54.2. Irrespective of the embodiment the threshold bar 50 has first and second edges 54.1,54.2 above the first and second panels 36.1, 36.2, the edges F36.1", F36.2" of the first and second panels 36.1, 36.2 being between the first and second edges 54.1, 54.2 of the threshold bar 50. The first and second edges 54.1, 54.2 of the threshold bar 50 are substantially parallel to one another. When the threshold bar 50 is in place its first and second edges 54.1, 54.2 are substantially parallel to the transverse direction Y.

Thus the first panel 36.1 of the floor 30 is between the first edges 40.1, 54.1 of the gutter 38 and the threshold bar 50 and the second panel 36.2 of the floor 30 is between the second edges 40.2, 54.2 of the gutter 38 and the threshold bar 50.

The threshold bar 50 includes at least a lower face F58.1 oriented toward the first or second panel 36.1, 36.2 and an upper face F60 opposite the lower face F58.1 oriented toward the exterior zone ZE. In one configuration the threshold bar 50 includes a first lower face F58.1 at the level of the first flange 56.1 oriented toward the first panel 36.1 and a second lower face F58.2 at the level of the second flange 56.2 oriented toward the second panel 36.2.

In one arrangement the upper face F60 has a convex shape substantially symmetrical relative to a second plane of symmetry PS2.

In one embodiment the threshold bar 50 includes at least one cutout and/or orifice configured to provide communication with the upper face F60 and the first or second lower face F58.1, F58.2.

In one configuration the threshold bar 50 includes first notches 62 at the level of the first edge 54.1 enabling communication between the upper face F60 and the first lower face F58.1 and/or second notches 64 at the level of the second edge 54.2 enabling communication between the upper face F60 and the second lower face F58.2. The first notches 62 are regularly distributed along the first edge 54.1 and/or the second notches 654 are regularly distributed along the second edge 54.2.

In one embodiment the second lower face F58.2 and the upper face F60 are spaced by an approximately constant distance, the second flange 56.2 having a substantially constant thickness. The first lower face F58.1 is substantially horizontal and parallel to the upper face F44.1 of the first flange 44.1 of the gutter 38. This first lower face F58.1 includes for each first notch 62 a transverse groove 62.1 substantially perpendicular to the first edge 54.1 of the threshold bar 50 that extends the first notch 62. The first and second notches 62, 64 form liquid inlets enabling liquids on the first and second panels 36.1, 36.2 to flow toward the gutter 38.

The connecting system 52 connecting the gutter 38 and the threshold bar 50 is configured to allow compression of the first and/or second panel 36.1, 36.2 between the first or second edges 40.1, 54.1 / 40.2, 54.2 of the gutter 38 and of the threshold bar 50.

In one arrangement the connecting system 52 is configured to allow compression of the second panel 36.2 between the second edges 40.2, 54.2 of the gutter 38 and the threshold bar 50. This second panel 36.2 is therefore immobile relative to the gutter 38 and the threshold bar 50.

In one embodiment the connecting system 52 includes at least one screw 66.1. Also the connecting system 52 includes for each screw an orifice 66.2 through the threshold bar 50 enabling passage of the screw 66.1 and a threaded hole 66.3 in the gutter 38 enabling the screw 66.1 to be screwed in. In one configuration each screw 66.1 has a milled head and the orifice 66.2 is chamfered so that the head of the screw 66.1 is flush with the upper surface F60 of the threshold bar 50.

In one arrangement the connecting system 52 includes a plurality of screws 66.1 regularly distributed in a direction substantially parallel to the first and second edges 54.1, 54.2 of the threshold bar 50 (this direction corresponding to the transverse direction Y) and for each screw 66.1 an orifice 66.2 in the threshold bar 50 and a threaded hole 66.3 in the gutter 38.

In one embodiment the connecting device 32 includes at least one positioning system 68 configured to position the threshold bar 50 relative to the gutter 38 in such a manner that the gutter 38 and the threshold bar 50 are oriented in the same direction, the first and second edges 40.1, 54.1 / 40.2, 54.2 of the gutter 38 and the threshold bar 50 being substantially parallel to one another.

In one configuration the positioning system 68 includes at least one median rib 70 that has a first end 70.1 rigidly attached to the gutter 38 and a free second end 70.2 as well as at least one median groove 72 at the level of the threshold bar 50 configured to house without clearance the free second end 70.2 of the median rib 70. By without clearance is meant that the median rib 70 is immobilised relative to the median groove 72 against movement in translation in the direction perpendicular to the median rib 70 (i.e. in the longitudinal direction X) when the second end 70.2 of the median rib 70 is in the median groove 72. In one arrangement the first end 70.1 of the median rib 70 is at the level of the bottom 38.1 of the gutter 38 and equidistant from the first and second edges 40.1, 40.2 of the gutter 38. The median rib 70 is therefore substantially parallel to the transverse direction Y. Also the median groove 72 is equidistant from the first and second edges 54.1, 54.2 of the threshold bar 50.

When a median rib 70 is present each threaded hole 66.3 of the connecting system 52 is in the median rib 70.

In a particular feature of the disclosure herein the gutter 38, the threshold bar 50 and the first and second panels 36.1, 36.2 are configured in such a manner as to enable movement of the first panel 36.1 at least in the longitudinal direction X when the second panel 36.2 is in the gap between the gutter 38 and the threshold bar 50.

In a first configuration, when the second panel 36.2 is between the gutter 38 and the threshold bar 50 without clearance the floor 30 has at least one clearance J between the first panel 36.1 and the gutter 38 and/or between the first panel 36.1 and the threshold bar 50. This clearance J also enables slight angular movement in a vertical direction Z.

In a first embodiment of the disclosure herein the first panel 36.1 has a thickness less than that of the second panel 36.2 at least at the level of the connecting device 42.

In a second embodiment, when the second panel 36.2 is between the gutter 38 and the threshold bar 50 without clearance the gutter 38 and the threshold bar 50 are separated by a first distance D1 in line with the first panel 36.1 greater than a second distance D2 in line with the second panel 36.2. The second distance D2 is equal to the thickness of the first or second panel 36.1, 36.2 and the first distance D1 is greater than the thickness E of the first panel 36.1.

In one arrangement the first edge 40.1 and/or the first flange 44.1 of the gutter 38 and the first edge 54.1 and/or the first lower face F58.1 of the threshold bar 50 are spaced by a first distance D1 greater than a second distance D2 separating the second edge 40.2 and/or the second flange 44.2 of the gutter 38 and the second edge 54.2 and/or the second lower face F58.2 of the threshold bar 50. In one embodiment of the disclosure herein, at the level of the gutter 38 the first edge 40.1 and/or the first flange 44.1 is nearer the bottom 38.1 than the second edge 40.2 and/or the second flange 44.2.

In a second configuration the floor 30 includes at least one first sliding element 74 between the gutter 38 and the first panel 36.1 and/or at least one second sliding element 74' between the threshold bar 50 and the first panel 36.1. Each sliding element 74, 74' has a low coefficient of friction with the first panel 36.1.

In one arrangement the floor 30 includes at least one first sliding element 74 between the gutter 38 and the first panel 36.1 and at least one second sliding element 74' between the threshold bar 50 and the first panel 36.1.

In one embodiment the first sliding element 74 is a sliding coating on the upper face F44.1 of the first flange 44.1 of the gutter 38 that covers substantially all the surface of the upper face F44.1 of the first flange 44.1. The second sliding element 74' is a bead rigidly attached to the threshold bar 50 including a plurality of sections between the transverse grooves 62.1. In one embodiment the second sliding element 74' is a T-section profile and the threshold bar 50 includes a T-section groove to house the profile at least partially.

In one embodiment of the disclosure herein each sliding element 74, 74' is made of polytetrafluoroethylene.

Of course the disclosure herein is not limited to these embodiments of the sliding elements 74, 74'. These latter elements could therefore be made of some other material favouring sliding, being rigidly attached to the panel 36.1, and slide relative to the gutter 38 and/or the threshold bar 50. Furthermore, at least one sliding element 74, 74' could be configured to be compressed elastically in order to allow slight relative movement in the vertical direction Z.

The first and second configurations can be employed separately or combined. The floor 30 therefore includes:

a. at least one sliding element 74 between the first panel 36.1 and at least a part of the connecting device 32, namely the gutter 38 and/or the threshold bar 50, and/or

at least one clearance J between the first panel 36.1 and at least a part of the connecting device 32, namely the gutter 38 and/or the threshold bar 50, when the second panel 36.2 is between the gutter 38 and the threshold bar 50 without clearance.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms "comprise" or "comprising" do not exclude other elements or steps, the terms "a", "an" or "one" do not exclude a plural number, and the term "or" means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A floor comprising first and second panels spaced from one another in at least a longitudinal direction and at least one connecting device connecting the first and second panels and including at least one threshold bar at least partly above the first and second panels, at least the first panel being mobile relative to the second panel at least in the longitudinal direction, the connecting device including at least one gutter configured to collect at least one liquid and at least partly below the first and second panels and at least one connecting system connecting the threshold bar and the gutter, the first panel being between the gutter and the threshold bar, the second panel being between the gutter and the threshold bar without clearance, and the floor including at least one clearance and/or at least one sliding element between the first panel and at least a part of the connecting device, which is the gutter and/or the threshold bar.

2. The floor according to claim 1, wherein the floor comprises at least one first sliding element between the gutter and the first panel and at least one second sliding element between the threshold bar and the first panel.

3. The floor according to claim 1, wherein the first and second panels respectively have first and second edges oriented toward one another and the gutter includes a bottom below the first and second panels and first and second edges on respective opposite sides of the bottom, the first and second edges of the first and second panels being between the first and second edges of the gutter.

4. The floor according to claim 3, wherein the first edge is nearer the bottom than the second edge.

5. The floor according to claim 3, wherein the gutter includes first and second flanges that extend the first and second edges on respective opposite sides of the latter, each having a substantially horizontal upper face oriented toward a corresponding first or second panel.

6. The floor according to claim 2, wherein the gutter includes first and second flanges that extend the first and second edges on respective opposite sides of the latter, each having a substantially horizontal upper face oriented toward a corresponding first or second panel, and wherein the first sliding element is a sliding coating rigidly attached to the upper face of the first flange of the gutter.

7. The floor according to claim 1, wherein the first and second panels respectively have first and second edges oriented toward one another and the threshold bar has first and second edges above the first and second panels, the first and second edges of the first and second panels being between the first and second edges of the threshold bar.

8. The floor according to claim 7, wherein the threshold bar has a first lower face oriented toward the first panel, a second lower face oriented toward the
second panel, an upper face opposite the first and second lower faces and at least one cutout and/or orifice configured to establish communication between the upper face and the first or second lower face.

9. The floor according to claim 8, wherein the threshold bar includes first notches on the first edge enabling communication between the upper face and the first lower face and/or second notches on the second edge enabling communication between the upper face and the second lower face.

10. The floor according to claim 9, wherein the first lower face is substantially horizontal and includes for each first notch a transverse groove extending the first notch.

11. The floor according to claim 2, wherein the first lower face is substantially horizontal and includes for each first notch a transverse groove extending the first notch, and wherein the second sliding element is a bead rigidly attached to the threshold bar including a plurality of sections between the transverse grooves.

12. The floor according to claim 1, wherein the gutter includes at least one evacuation orifice enabling the liquid to exit the gutter.

13. The floor according to claim 1, wherein the connecting device includes at least one positioning system configured to position the threshold bar relative to the gutter such that the gutter and the threshold bar are oriented in a same direction.

14. The floor according to claim 13, where the positioning system includes at least one median rib that has a first end rigidly attached to the gutter and a free second end as well as at least one median groove in the threshold bar configured to house without clearance the free second end of the median rib.

15. The floor according to claim 14, wherein the connecting system includes at least one screw and for each screw an orifice through the threshold bar and a threaded hole in the median rib.

16. An aircraft including at least one floor according to claim 1.
